(19) United States
(12) Patent Application Publication
(10) Pub. No.: US 2021/0405386 A1
(43) Pub. Date: Dec. 30, 2021

(54) DISPLAY APPARATUS USING DIFFRACTION UNIT

(71) Applicant: EPICOPTIX, Seongnam-si, Gyeonggi-do (KR)

(72) Inventors: Dong Ha KIM, Yongin-si, Gyeonggi-do (KR); Young Il KIM, Seongnam-si, Gyeonggi-do (KR); Byeong Soo SON, Suwonsi, Gyeonggi-do (KR); Gye Won SEO, Gwangju-si, Gyeonggi-do (KR)

(73) Assignee: EPICOPTIX, Seongnam-si, Gyeonggi-do (KR)

(21) Appl. No.: 16/490,607

(22) PCT Filed: Apr. 30, 2019
(86) PCT No.: PCT/KR2019/005190

§ 371 Date: Sep. 3, 2019

(30) Foreign Application Priority Data
May 17, 2018 (KR) 10-2018-0056421

(51) Int. Cl. G02B 27/42; G02B 27/01; F21V 8/00

(52) U.S. Cl. CPC G02B 27/4205; G02B 6/005; G02B 27/0101

(57) ABSTRACT

A display apparatus includes: an output unit to form an image and output it to the front; a lens unit disposed in front of the output unit to transmit the image to be output and transfer the image to the front; a guide unit formed to be long and having at least one pair of total reflection surfaces, a part of which is disposed between the output unit and the lens unit, in which a transmission path through which the illumination light is incident to move to the other side through at least one or more internal total reflections is formed; and a diffraction unit which is disposed on the transmission path and transmits the illumination light incident with a predetermined pattern to the output unit at a predetermined angle.

### TECHNICAL FIELD

The present invention relates to a display apparatus using a diffraction unit, and more particularly, to a display apparatus using a diffraction unit which transfers the illumination light whose characteristics are changed through a preset DOE pattern to an output unit, thereby easily adjusting the size of a lens unit.

### BACKGROUND ART

Recently, a lot of technologies for virtual reality or augmented reality are developed, and display apparatus in the form of goggle which can be worn directly and used by the user are already commercialized.

Among these devices, augmented reality is currently in the spotlight. The augmented reality refers to a technology that overlays a virtual image on an environment that we actually see to make: it appear as if a virtual object exists together in reality.

In general, since the augmented reality device is worn on the head directly by the user and a lens is disposed in front of the field of view, it is very important to reduce the weight or size.

Recently, a DLP, a liquid crystal display, or the like is used as a display apparatus for outputting an image from such an augmented reality device or an optical device.

However, when using a liquid crystal display (LCD) or a DLP, the illumination light is essentially used. In this case, various types of lenses, mirrors, or prisms are provided to transfer the illumination light at an appropriate angle to adjust the movement path or refraction of the illumination light.

In order to properly transfer the illumination light, since a lens, a mirror, or a prism needs to be disposed adjacent to the display apparatus, a predetermined level or more space is required.

However, the size of lens or mirror to transfer the illumination light is limited, and thus the separation distance between the output unit and the transmission lens is limited.

As the separation distance between the output unit and the transmission lens is limitedly selected, the size of the transmission lens is correspondingly determined. In particular, when the illumination light is transmitted using a plurality of mirrors, lenses, or prisms, there a problem that the separation distance between the output unit and the transmission lens is increased due to their size, and thus the size of the transmission lens itself also increases.

The problem is directly related to the size of the display apparatus, and therefore, it is urgent to solve the problem for miniaturization.

### DISCLOSURE

### Technical Problem

It is an object of the present invention to solve the problems of the conventional display apparatus, more specifically, to provide a display apparatus using a diffraction unit which allows the illumination light for the output of images to be transferred via a predetermined DOE pattern, thereby Selectively adjusting the size of the guide unit for transfer of the illumination light to reduce the constraint on the overall size of the device.

### Technical Solution

In order to resolve the problems, the present invention provides a display apparatus including: an output unit to form an image and output it to the front; a lens unit disposed in front of the output unit to transmit the image to be output and transfer the image to the front; a guide unit formed to be long and having at least one pair of total reflection surfaces, a part of which is disposed between the output unit and the lens unit, in which a transmission path through which the illumination light incident from one side moves to the other side through at least one or more internal total reflections is formed; and a diffraction unit which is disposed on the transmission path and transmits the incident illumination light with a predetermined pattern to the output unit at a predetermined angle; wherein the diffraction unit selectively refracts or reflects the light corresponding to the characteristic of the incident illumination light to transmit the refracted or reflected light in a predetermined direction.

In addition, the guide unit includes the total reflection surfaces which are integrally formed of the light transmissive material and face each other, which enables the incident illumination light to be transferred to the output unit via the diffraction unit.

In addition, the guide unit may further include an auxiliary total reflection surface which is provided at one end portion in the longitudinal direction and reflects the illumination light incident at a predetermined inclination angle with respect to the total reflection surface.

In addition, the diffraction unit may refract or reflect the light corresponding to a pattern selectively predetermined according to the characteristic of the incident illumination light.

In addition, the diffraction unit may transmit the illumination light incident on the transmission path.

In addition, the diffraction unit may be provided on the total reflection surface inside the guide unit.

In addition, the diffraction unit may reflect the illumination light incident on the transmission path.

In addition, the diffraction unit may include a first diffraction portion which has a first DOE pattern and is disposed adjacent to the output unit on the other side of the guide unit along the transmission path and a second diffraction portion which is spaced apart from the first diffraction portion inside the guide unit and has a second DOE pattern.

In addition, the diffraction unit may include a hologram optical element (HOE), and refract or reflect the light in a predetermined direction corresponding to the characteristic of the incident illumination light.

In addition, the output unit may selectively reflect at least a part of the incident illumination light, form an image, and transmit the image to the front.

### Advantageous Effects

According to the present invention to solve the above problems, it has the following effects.

First, the diffraction unit may be provided inside the guide unit to stably transfer the illumination light to the output unit even when the guide unit itself is thinly formed.

Second, the size of the guide unit itself can be reduced by the diffraction unit, and thus the separation distance between the lens unit and the output unit can be reduced, thereby miniaturizing the overall device.

The effects of the present invention are not limited to the above-described effects, and other effects not described herein will be clearly understood by those skilled in the art from the description of the claims.

### DESCRIPTION OF DRAWINGS

FIG. 1 is a view showing the structure: of an output unit in display apparatus using a diffraction unit according to the present invention.

FIG. 2 is a view showing a state in which the illumination light is reflected by the output unit of FIG. 1.

FIG. 3 is a view showing the configuration of a display apparatus using a diffraction unit according to the present invention.

FIG. 4 is a view showing the principle of the diffraction unit of FIG. 3.

FIG. 5 is a diagram of another form illustrating the principle of the diffraction unit of FIG. 3.

FIG. 6 is a view showing a state in which an image is output from the output unit by the display apparatus according to the present invention.

FIG. 7 is a view showing the structure of conventional display apparatus.

FIG. 8 is a view showing an arrangement type according to the type of diffraction unit in the display apparatus according to the present invention.

FIGS. 9 to 12 are views showing a state in which a plurality of diffraction units are configured in the display apparatus according to the present invent on.

### BEST MODE

Hereinafter, a preferred embodiment of the display apparatus using the diffraction unit according to the present invention configured as described above will be described with reference to the accompanying drawings. However, this is not intended to limit the present invention to a specific form, but to help a more clear understanding through the present embodiment.

In addition, in describing the present embodiment, the same name and the same reference numerals are used for the same configuration and additional description thereof will be omitted.

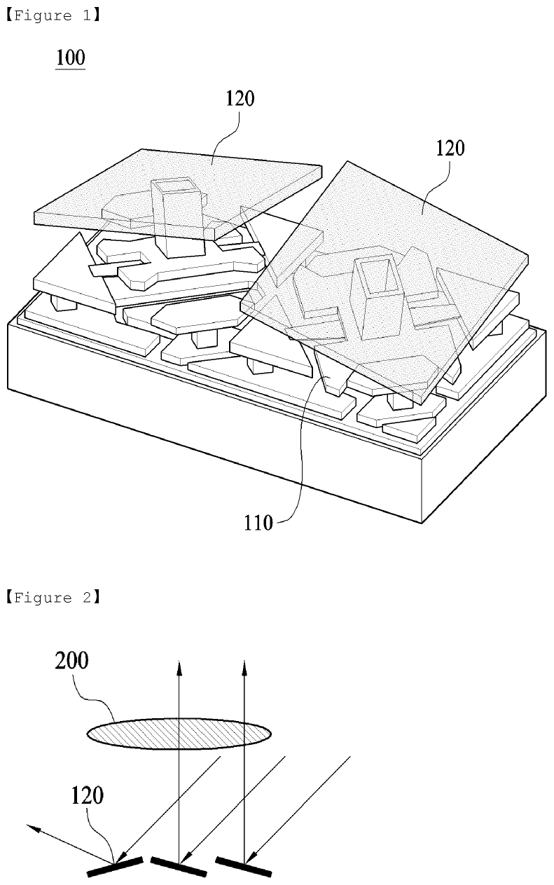

First, the configuration of the display apparatus using the diffraction unit according to the present invention will be described with reference to FIGS. 1 to 5.

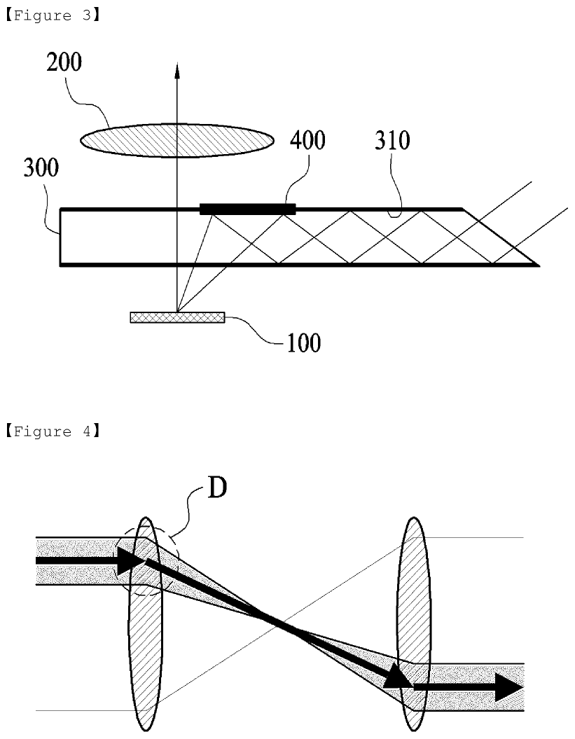

FIG. 1 is a view showing the structure of the output unit in the display apparatus according to the present invention, and FIG. 2 is a view showing a state in which the illumination light is reflected by the output unit of FIG. 1.

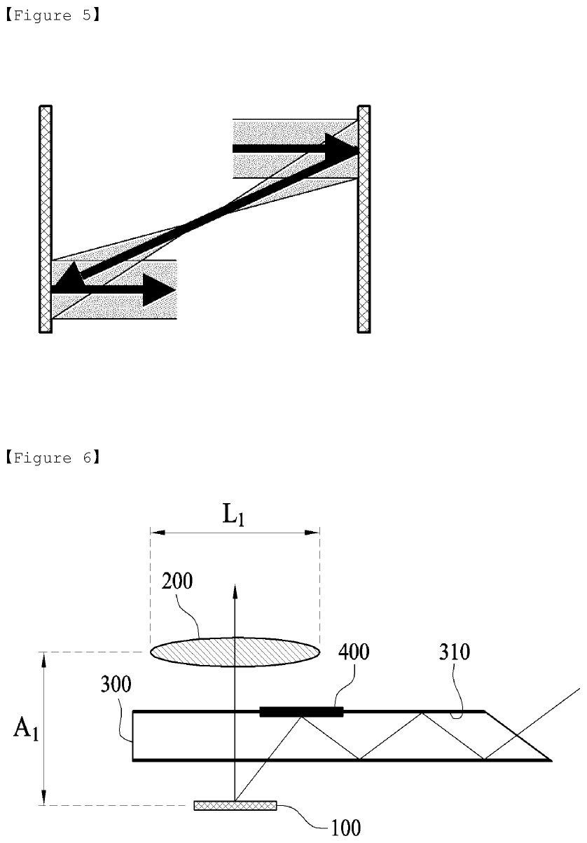

And, FIG. 3 is a view showing the configuration of a display apparatus using a diffraction unit according to the present invention, FIG. 4 is a view showing the principle of the diffraction unit of FIG. 3, and FIG. 5 is another drawing showing the principle of the diffraction unit of FIG. 3.

The display apparatus using the diffraction unit 400 according to the present invention is a device for transferring the illumination light to the output unit 100 in a specific form so that the image can be output to the front.

Here, as a configuration for outputting an image, a liquid crystal display (LCD), or a DLP or a LCOS using a micro mirror is used, which receives the illumination light and outputs the image to the front.

Therefore, in order to implement an image in the display apparatus, it is necessary to accurately transfer the light to the position of the mirror.

Roughly referring to the configuration of the display apparatus according to the present invention, the output unit 100, the lens unit 200, the guide unit 300, and the diffraction unit 400 are included mainly.

As the output unit 100 is configured to output an image transmitted to the user to the front, the output unit 100 transmits or reflects the illumination light transmitted from the outside to output the image.

Specifically, the output unit 100 may be configured in various forms. In the present invention, the output unit 100 receives the illumination light and outputs the image to the front by using the illumination light. Here, the output unit 100 is configured to output the image by receiving and reflecting the illumination light, otherwise the output unit 100 is configured to output the image to the front by not reflecting the illumination light but transmitting the illumination light.

In the present embodiment, the output unit includes a plurality of tilting mirrors 120, and the tilting mirror 120 is configured to form an image by selectively reflecting the illumination light to output the image to the front.

Specifically, in the output unit 100, the plurality of tilting mirrors 120 correspond to respective pixels, and each tilting mirror selectively reflects a part of the incident illumination light. In this case, each of the tilting mirrors 120 may be driven independently, may be tilted according to the type of the incident illumination light, and may be adjusted for reflection.

Here, the tilting mirrors 120 are provided in the pixels, respectively, and the tilting angle thereof is adjusted independently to selectively reflect the illumination light forming the image. In addition, since the tilting mirror 120 is tilted at a limited angle in configuration, the illumination light must be incident at a predetermined level to reflect the incident illumination light to the front.

In the present invention, the output unit 100 outputs the elements constituting the image in the pixel by reflecting the illumination light transferred by the guide unit 300, which will be described later, by the tilting mirror 120 and transmitting the reflected light to the lens unit 200. In this case, the illumination light is configured with RGB using an LED or a laser, is incident repeatedly, and may be adjusted for the reflection with respect to each of them by the tilting mirror to form an image forward.

Therefore, the output unit 100 is provided with a plurality of the tilting mirrors 120 as shown, each is provided with a tilting means 110 for controlling the tilting angle, which is driven independently.

As described above, the output unit 100 selectively reflects the illumination light by the operation of the tilting mirror 120, adjusts the output of the pixel, and forms and outputs the image to the front.

On the other hand, unlike the present embodiment, the output unit 100 may be configured to output the image to the front by reflecting the illumination light and transmitting the illumination light without outputting the image.

In particular, when the output unit 100 is configured with a transmissive LCD, the illumination light is essential and can receive the illumination light from the guide unit 300 which will be described later and output the image to the front.

In this way, the output unit 100 receives the illumination light and reflects or transmits the light, thereby outputting the image to the front and transferring the image to the lens unit 200 which will be described later.

The lens unit 200 is disposed in front of the output unit 100, transmits the image to be output, and transfers it so that the user can recognize the image.

The lens unit 200 is configured to diffuse and refract the image output from the output unit 100 so that a user can recognize it. In the present invention, the lens unit 200 is configured with a projection lens.

Specifically, the lens unit 200 is made of a light transmissive material and is disposed on the transmission path of the image output from the output unit 100 to transfer the image to the front by refracting and diffusing the image.

At this time, the lens unit 200 may be disposed at least one or more consecutively so that the user can correctly recognize the image output from the output unit 100, and it may also be configured in various forms.

As described above, the lens unit 200 transfers the image formed by selectively reflecting the illumination light transmitted through the guide unit 300 which will be described later from the output unit 100 so that the user can recognize the image.

On the other hand, the guide unit 300 is a configuration for transferring the illumination light to the output unit 100, and the transmission path is formed therein to be long at a predetermined length.

Specifically, the guide unit 300 is formed to be long and has a pair of total reflection surfaces 310 disposed to face each other, and the transmission path through which the illumination light moves along the longitudinal direction is formed between the total reflection surfaces 310.

At this time, the total reflection surface 310 is composed of at least one pair having a predetermined separation distance and being disposed mutually spaced apart, and the illumination light transmitted from one side is reflected repeatedly along the transmission path and is transmitted to the other side. Here, the guide unit 300 is provided with the diffraction unit 400 therein to reflect or refract the illumination light at a predetermined angle.

In the present invention, the guide unit 300 is filled with a light transmissive material having a relatively high refractive index relative to the outside air to form the transmission path, and is configured to have a plurality of total reflection surfaces 310, whereby the illumination light is transferred on or more times along the longitudinal direction through internal total reflection. And, at least one of the total reflection surfaces 310 may be disposed on a path through which the illumination light moves so that the illumination light can be reflected or refracted.

Further, a separate light source (not shown) is provided on one side of the guide unit 300 so that the illumination light is internally total-reflected by the total reflection surface 310 and is incident so as to move along the guide unit 300.

In general, in order for total reflection to occur, light is transferred from a dense medium to a rare medium, and the light must be incident on the total reflection surface 310 at an angle greater than a critical angle.

Therefore, when the guide unit 300 is configured with a light transmissive material as in the present invention, the transmission path is filled with the material having a relatively larger density than the outside and in the present embodiment the transmission path is filled with the same material as the total reflection surface 310.

That is, the guide unit 300 is configured integrally with a material such as glass or synthetic resin, and a pair of the total reflection surfaces 310 facing each other is formed.

The illumination light is incident inside through one side of the guide unit 300 configured as described above, and is totally reflected along the transmission path and transferred to the other side.

And, the image output from the output unit 100 can be transferred to the user's field of view by the illumination light transmitted along the transmission path from the other side of the guide unit 300.

In this embodiment, the guide unit 300 has a rectangular cross-sectional shape, the total reflection surface 310 is formed therein, but may be configured to have a cross-sectional shape of various forms such as circle or polygon.

Accordingly, the illumination light that moves along the guide unit 300, as shown in FIG. 3, is transferred to the output unit 100 by the total reflection surface 310, and the output unit 100 selectively reflects a part of the illumination light and outputs the image to the front.

Therefore, the guide unit 300 according to the present invention has at least a pair of the total reflection surfaces 300 disposed to be faced with each other, and is integrally formed of light transmissive material so that the light is total-reflected therein.

As described above, the guide unit 300 transfers the illumination light emitted from the light source to the output unit 100, and thereby the output unit 100 may output the image so that the user can recognize the image.

On the other hand, the diffraction unit 400 is provided inside the guide unit 300, and reflects and refracts the illumination light incident through a predetermined pattern in a specific direction and transmits it.

Specifically, the diffraction unit 400 is provided as at least one or more and is disposed on the transmission path, and the illumination light is refracted or reflected via the diffraction unit 400 within the guide unit 300. In this case, the diffraction unit 400 selectively refracts and reflects the illumination light corresponding to the characteristic of the incident illumination light to transmit it in a predetermined direction.

The diffraction unit 400 according to the present invention is formed in the form of a sheet and a predetermined DOE pattern is formed on the surface, wherein it is configured to reflect or refract the light on the path through which the illumination light is transferred.

Here, DOE means a diffractive optical element wherein a diffraction effect can be obtained by forming a specific pattern on the surface of a lens or a sheet. In the case of a lens or a sheet having such a DOE pattern, incident light is diffracted to have a specific shape or transmitted in a specific direction.

As described above, the diffraction unit 400 reflects and refracts the light while converting the light into a light having a selectively set form according to the characteristic of the incident light.

In the present embodiment, the diffraction unit 400 is provided on the total reflection surface 310 as shown in FIG. 3, and is configured to reflect the illumination light. In this case, the diffraction unit 400 is formed in the form of a sheet and is disposed on the total reflection surface 310 at the position facing the output unit 100 to reflect the illumination light.

Accordingly, the illumination light that is totally reflected inside through the total reflection surface 310 and moves is transferred to the output unit 100 in the form of being reflected by the diffraction unit 400 at the other side of the guide unit 300 and simultaneously converged.

That is, the illumination light is reflected inside the guide unit 300 while there is no characteristic change, but the illumination light moves while the light property changes as it passes through the diffraction unit 400. In this embodiment, as shown, the illumination light is changed into a converging shape by the diffraction unit 400.

In this case, the diffraction unit 400 diffracts the incident light in correspondence to a predetermined pattern, in which a general pattern of diffractive optical element (DOE) is formed, and reflects or refracts the incident light in a specific direction.

For example, referring to FIGS. 4 and 5, as shown in FIG. 4, in the case of general parallel light, the light is refracted in a convergent form via lens to form a focus, and the light is diverged through the focus and passes through the same lens again to be converted into a parallel light.

At this time, when the parallel light is incident on the area with separately setting the pattern of the shape corresponding to the area D in FIG. 4, it can be seen that the position of the focal point P does not change, but all the parallel light is biased to one side and refracted.

Referring to this principle, by changing the parallel light to the total reflection surface 310 instead of the lens, and at the same time forming the pattern of the above-described D area on the surface of the total reflection surface 310, as shown in FIG. 5, the incident light can be reflected with being biased to one side and converted into a convergent light form at the same time.

This is because the pattern formed on the total reflection surface 310 is formed as a DOE pattern functioning as a region D, as shown, and the parallel light incident thereto is biased in a predetermined direction to be reflected in the form of convergent light.

In the present embodiment, the diffraction unit 400 has a holographic optical element (HOE) pattern which is a type of diffractive optical element (DOE) as a diffraction pattern, and reflects and refracts the illumination light using the principle of hologram.

Here, the HOE pattern is generally formed as a pattern of an interference fringe at a point where two types of reference light and object light meet each other to be interfered. At this time, when one of the reference light and the object light is incident on the HOE pattern formed by the interference fringe, it is reflected as one remaining light form by the remaining diffraction and interference.

Therefore, in a case of the diffraction unit 400 of the present invention, the illumination light incident in the form of parallel light corresponds to the reference light, and the illumination light biased and reflected in the form of the refracted light corresponds to the object light.

As such, the display apparatus according to the present invention includes the output unit 100, the lens unit 200, the guide unit 300, and the diffraction unit 400, wherein the illumination light output from the light source is total-reflected inside the guide unit 300 to move, and is transferred to the mirror unit 100 in a state where the optical characteristic is changed by the diffraction unit 400.

Further, the output unit 100 outputs the image to the front by transferring the illumination light to the output unit 100 in a space defined by the guide unit 300 and the diffraction unit 400.

Accordingly, by minimizing the separation distance between the output unit 100 and the lens unit 200, the overall size of the display apparatus according to the present invention can be reduced to facilitate downsizing.

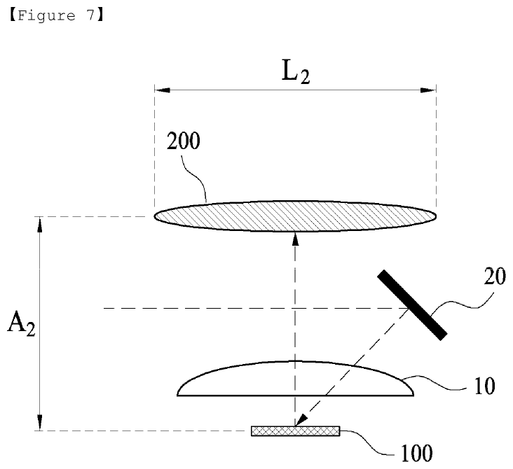

Next, the difference between the display apparatus according to the present invention and the conventional display apparatus will be described with reference to FIGS. 6 and 7 as follows.

FIG. 6 is a view showing a state in which an image is output from the output unit by the display apparatus according to the present invention, and FIG. 7 is a view showing the structure of a conventional display apparatus.

First, referring to FIG. 6, a display apparatus according to a first embodiment of the present invention is shown, wherein the guide unit 300 is formed to be long and the other side thereof is disposed between the output unit 100 and the lens unit 200. In addition, the diffraction unit 400 adjacent to the other side of the guide unit 300 along the longitudinal direction is disposed so that the illumination light is transferred to the output unit 100 in the form of convergent light.

Here, since the illumination light moves while being total-reflected inside the guide unit 300, the thickness of the guide unit 300 itself can be easily adjusted, and thus the separation distance between the output unit 100 and the lens unit 200 can be reduced.

Specifically, as illustrated, the guide unit 300 is disposed between the lens unit 200 and the output unit 100 while the size thereof is adjusted, and as a result, the separation distance between the lens unit 200 and the output unit 100 becomes A1.

In addition, the width of the lens unit 200 is L1 corresponding to the length of A1. Here, the lens unit 200 is configured to transfer the image reflected by the output unit 100 so that the user can recognize as described above, and the image is diffused further as it is far away from the output unit 100 to have a width corresponding thereto.

That is, the separation distance between the lens unit 200 and the output unit 100 is determined according to the size of the guide unit 300, and thus the width of the lens unit 200 is determined according thereto.

On the other hand, FIG. 7 shows an example of a conventional display apparatus, and comprises at least one prism, a lens and the like instead of the guide unit 300 of the present invention.

Specifically, the conventional display apparatus is configured to receive the illumination light from the direction intersecting the output direction of the image through a combination of a plurality of lenses or prisms to transfer it to the output unit 100 through refraction and reflection.

At this time, a prism or a reflecting mirror 20 arranged to transfer the illumination light is used, and when using a combination thereof, a predetermined space or more must be secured in front of the output unit 100.

For example, as shown in FIG. 7, a conventional display apparatus includes a reflection mirror 20 for reflecting light transmitted from a light source and a viewing lens 10 for transferring light reflected from the reflection mirror 20 to the front.

Here, since the reflective mirror 20 and the viewing lens 10 are configured with a general optical lens and mirror, an angle of incidence is determined by using a geometrical optical characteristic so as to correctly transfer the illumination light incident from a light source to the output unit 100. At this time, the size and position of the reflection mirror 20 and the viewing lens 10 are adjusted by the characteristics of the prism, the lens and the like.

As a result, the conventional display apparatus transfers the illumination light through the reflective mirror 20 and the viewing lens 10, unlike the embodiment of the present invention described above, and the separation distance between the lens unit 200 and the output unit 100 becomes A2. The width of the lens unit 200 is determined to be L2 corresponding to the length A2, which is a distance between the output unit 100 and the lens unit 200.

Here, A2 has a relatively larger length than the separation distance A1 of the lens unit 200 and the output unit 100 according to the configuration of the present invention because a plurality of prisms or lenses are used to transfer the illumination light.

In particular, in the case of the present invention, a thin guide unit 300 is used rather than a simple combination of lens or prism, thereby drastically reducing the separation distance between the lens unit 200 and the output unit 100 and thus having a distance of A1.

Therefore, in the conventional display apparatus, the width L2 of the lens unit 200 is inevitably formed to be relatively larger than the width L1 of the lens unit 200 of the present invention, thereby increasing the size of the device itself.

However, since the present invention is provided with the diffraction unit 400 inside the guide unit 300 as described above, even if the guide unit 300 itself is formed thinly, it can stably transfer the illumination light to the output unit 100.

Therefore, the present invention can reduce the size itself of the guide unit 300 by the diffraction unit 400, and thus it can reduce the separation distance between the lens unit 200 and the output unit 100, thereby miniaturizing the whole apparatus.

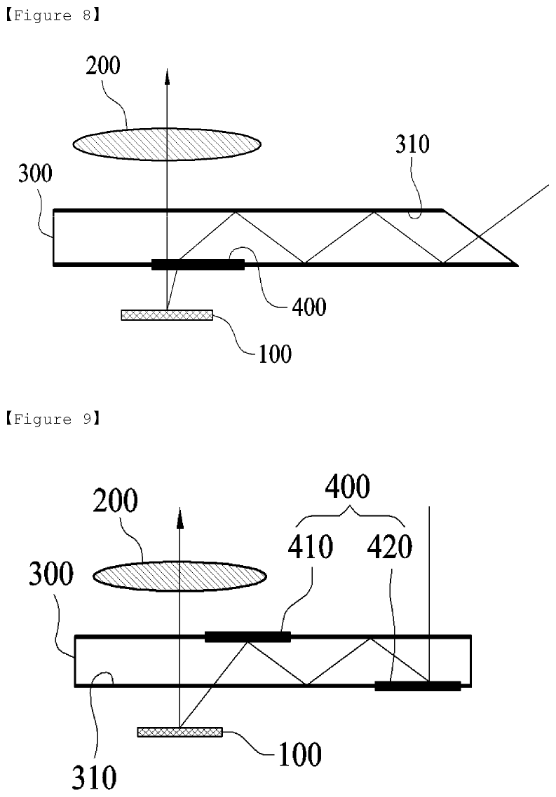

Subsequently, the modified form of the guide unit 300 in the display apparatus according to the present invention will be described with reference to FIGS. 8 to 12.

FIG. 8 is a view showing an arrangement type according to the type of diffraction unit 400 in the display apparatus according to the present invention, and FIG. 9 is a view showing a state in which a plurality of diffraction units 400 are configured in the display apparatus according to the present invention.

Referring to FIG. 8, unlike the above-described embodiment, the diffraction unit 400 does not reflect the illumination light but transmits the illumination light.

Specifically, the diffraction unit 400 is provided on the total reflection surface 310. However, the diffraction unit 400 is provided not on the total reflection surface 310 facing with the output unit 100 but on the position directing to the output unit 100 in the same type, thereby refracting the transmitted light to be transmitted.

Here, the illumination light to be transmitted may be transmitted through the guide unit 300 together from the other side thereof and be transferred to the output unit 100. That is, the diffraction unit 400 may be formed with a DOE pattern in the form of refracting and reflecting the light unlike the above-described embodiment, and disposed at a suitable position on the guide unit 300.

As described above, the diffraction unit 400 according to the present invention may reflect or refract the incident light, and the arrangement position may also be adjusted according to the characteristics thereof. In particular, although the diffraction unit 400 is provided on the total reflection surface 310 in the present embodiment, it may be arranged in the position which can be transmitted on the transmission path of the illumination light.

On the other hand, referring to FIGS. 9 to 12, unlike the above-described embodiment, the diffraction unit 400 may be configured with plural pieces.

Specifically, the diffraction unit 400 includes a first diffraction portion 410 disposed adjacent to the output unit 100 and a second diffraction portion 420 spaced apart from the first diffraction portion 410.

The first diffraction portion 410 has a first DOE pattern, is provided on the other side of the guide unit 300 along the transmission path, and is configured to transmit or reflect the illumination light. Here, the first DOE pattern transforms the image in the form of parallel light flowing from the front into convergent light to transfer the transformed light to the output unit 100.

On the other hand, the second diffraction portion 420 is provided on one side of the guide unit 300, and may refracts or reflects the light incident on the guide unit 300 to be totally reflected therein and stably transferred to the first diffraction portion 410. Here, the second diffraction portion 420 is formed with a second DOE pattern separately from the first diffraction portion 410 so that the illumination light is refracted or reflected in correspondence to the first diffraction portion.

In this case, in the present embodiment, the first DOE pattern and the second DOE pattern are formed to include a holographic optical element (HOE). Alternatively, only one of the first and second DOE patterns may include the holographic optical element. This may be selectively transformed according to the length or shape of the guide unit 300 or the arrangement of the total reflection surface 310.

As described above, the diffraction unit 400 may be configured with plural pieces, and includes, for example, the first diffraction portion 400 and the second diffraction portion 420 as in the present embodiment.

Specifically reviewing the diffraction unit 400 according to the present embodiment, in the case of FIG. 9, both the first diffraction portion 410 and the second diffraction portion 420 are configured to reflect the illumination light. Accordingly, the illumination light is moved from the guide unit 300 to the other side, and then transferred to the output unit 100.

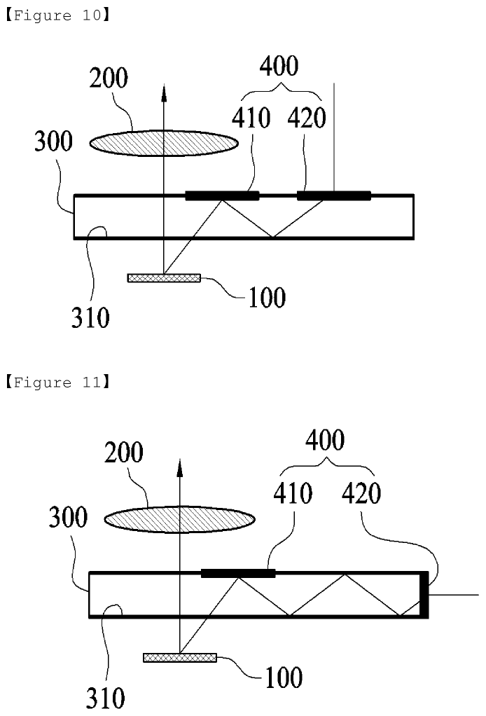

On the contrary, referring to FIG. 10, the first diffraction portion 410 is formed in a reflective type and the second diffraction portion 420 is formed in a transmissive type, which are provided on the total reflection surface 310, respectively. In this case, the first diffraction portion 410 and the second diffraction portion 420 are provided on the total reflection surface 310 as shown and each of them transmits and reflects the illumination light.

Meanwhile, unlike FIG. 10 above, referring to FIG. 11, the first diffraction portion 410 is formed in a reflective type and the second diffractive portion 420 is formed in a transmissive type. However, unlike the above-described form, the second diffractive portion 420 is formed on the side of the guide unit 300 instead of the total reflection surface 310 to make the illumination light incident into the guide unit 300.

As described above, the diffraction portion 400 is configured with plural pieces including the first diffraction portion 410 and the second diffraction insertion portion, independently reflects or refracts the illumination light, and transfers the illumination light to the output unit 100.

Unlike the above, the diffraction unit 400 may also be configured with more additional pieces in addition to the first diffraction portion 410 and the second diffraction portion 420 and each of them may independently reflect and refract the illumination light.

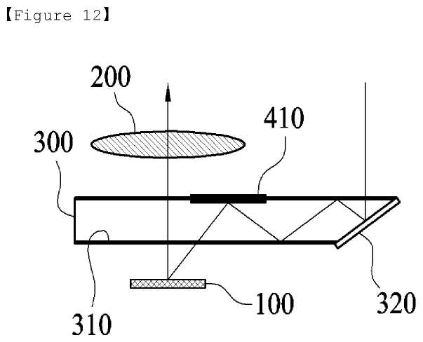

In addition, referring to FIG. 12, the diffraction unit 400 is configured as one, but further includes a separate auxiliary total reflection surface 320 in the guide unit 300.

Specifically, the auxiliary total reflection surface 320 is formed to have an inclination at one side of the guide unit 300 to reflect the incident illumination light into the guide unit 300. In this case, since the auxiliary total reflection surface 320 is formed to be inclined at a predetermined angle along the longitudinal direction of the guide unit 300, the auxiliary total reflection surface 320 is disposed to reflect at an angle which is not perpendicular to the angle at which the illumination light is incident.

As such, the guide unit 300 and the diffraction unit 400 convert the illumination light incident in various forms into a predetermined pattern and transfer the converted light to the output unit 100. In addition, the guide unit 300 may transfer the illumination light to the output unit 100 even at a small size due to the presence of the diffraction unit 400 while moving along the longitudinal direction through the total internal reflection.

As described above, preferred embodiments of the present invention have been described, and in addition to the above-described embodiments, it may be embodied in other forms without departing from the purport or scope of the present invention. Therefore, it should be understood that the present embodiments are illuminative rather than being limited to a specific form, and thus the present invention may be modified within the scope of the appended claims and their equivalents without being limited to the foregoing description.

1. A display apparatus, comprising:
an output unit to form an image and output it to the front;
a lens unit disposed in front of the output unit to transmit the image to be output and transfer the image to the front;
a guide unit formed to be long and having at least one pair of total reflection surfaces, a part of which is disposed between the output unit and the lens unit, in which a transmission path through which the illumination light incident from one side moves to the other side through at least one or more internal total reflections is formed; and
a diffraction unit which is disposed on the transmission path and transmits the incident illumination light with a predetermined pattern to the output unit at a predetermined angle;
wherein the diffraction unit selectively refracts or reflects the light corresponding to the characteristic of the incident illumination light to transmit the refracted or reflected light in a predetermined direction.

2. The display apparatus according to claim 1, wherein the guide unit comprises the total reflection surfaces which are integrally formed of the light transmissive material and face each other, which enable the incident illumination light to be transmitted to the output unit via the diffraction unit.

3. The display apparatus according to claim 1, wherein the guide unit further comprises an auxiliary total reflection surface which is provided at one end portion in the longitudinal direction and reflects the illumination light incident at a predetermined inclination angle with respect to the total reflection surface.

4. The display apparatus according to claim 1, wherein the diffraction unit refracts or reflects corresponding to a pattern selectively predetermined according to the characteristic of the incident illumination light.

5. The display apparatus according to claim 4, wherein the diffraction unit transmits the illumination light incident on the transmission path.

6. The display apparatus according to claim 4, wherein the diffraction unit is provided on the total reflection surface inside the guide unit.

7. The display apparatus according to claim 6, wherein the diffraction unit reflects the illumination light incident on the transmission path.

8. The display apparatus according to claim 4, wherein the diffraction unit comprises a first diffraction portion which has a first DOE pattern and is disposed adjacent to the output unit on the other side of the guide unit along the transmission path; and a second diffraction portion which is spaced apart from the first diffraction portion inside the guide unit and has a second DOD pattern.

9. The display apparatus according to claim 1, wherein the diffraction unit comprises a hologram optical element (HOE), and refracts or reflects the light in a predetermined direction corresponding to the characteristic of the incident illumination light.

10. The display apparatus according to claim 1, wherein the output unit selectively reflects at least a part of the incident illumination light, forms an image, and transfers the image to the front.
